(19) United States
(12) Patent Application Publication
(10) Pub. No.: US 2022/0266177 A1
(43) Pub. Date: Aug. 25, 2022

(54) SEPTIC TANK AUTOMATIC EFFLUENT FILTER CLEANING SYSTEM

(71) Applicant: COUNTRYSIDE PLUMBING SEWER AND SEPTIC, Antioch, IL (US)

(72) Inventor: Jordan JOHNSON, Antioch, IL (US)

(21) Appl. No.: 17/678,349

(22) Filed: Feb. 23, 2022

Related U.S. Application Data
(60) Provisional application No. 63/207,355, filed on Feb. 23, 2021.

(51) Int. Cl. B01D 33/50; B01D 33/06; B01D 33/80; B01D 36/04

(52) U.S. Cl. CPC B01D 33/50; B01D 33/06; B01D 33/804; B01D 36/04

(57) ABSTRACT

The invention includes an automatic effluent filter cleaning system that prevents sewage backups. The system includes an outlet baffle with filter, spray assembly, inlet and outlet flappers, pump, and strainers. The spray assembly actuates the baffles to control effluent flow prior, during, and after the cleaning process. During a high-water level condition, the pump engages and pumps effluent water from the septic tank to close the inlet flapper to prevent additional effluent water from entering the outlet baffle. Similarly, effluent water is pumped to close the outlet flapper to prevent effluent water from leaving the baffle. Spray outlets spray effluent water to remove debris from the filter. An outer chamber receives and channels the debris to strainers, which retain the removed debris while allowing the effluent water to return to the septic tank. Once the water level recedes to a safe level, the flappers are opened, and operation resumes.

### CROSS-REFERENCE TO RELATED APPLICATION

This application claims benefit of priority from U.S. Provisional Application No. 63/207,355 filed on Feb. 23, 2021, the entire contents of which are incorporated by reference.

### TECHNICAL FIELD

The invention relates to systems and methods for cleaning effluent filters to prevent septic system backups, and more specifically, to automatic cleaning of effluent filters in gravity-driven septic tanks without a lift station (pump tank) moving water from a lower elevation to a higher elevation.

### BACKGROUND

Septic systems are wastewater treatment systems that collect, treat, and disperse wastewater generated by a home or business. Domestic wastewater is water discharged from plumbing fixtures, appliances, toilets, baths, laundry, and dishwashers. Wastewater is typically 99.9% liquid. The wastewater is treated on-site, rather than collected and transported to a wastewater treatment plant.

A typical septic system includes two main components: a septic tank and a soil absorption system (also known as a drain field or leach field). Underground pipes connect the system. Septic systems typically include a main drainage pipe through which wastewater leaves a house and is received in the septic tank. The main drainage pipe of a septic system is generally a rigid pipe (e.g., PVC) that collects wastewater from plumbing fixtures and appliances. The pipe is laid at a downward slope, exits the building, and extends to a pretreatment part of the system that includes the septic tank. Wastewater leaving the building and exiting through the collection section is typically gravity driven.

Wastewater flows from the drainage pipe to the septic tank. Septic tanks are the main units of the pretreatment portion of a septic system. Septic tanks are buried, water-tight containers usually made of concrete, fiberglass, or polyethylene. Septic tanks are used to settle out solids and to partially treat wastewater before it reaches the distribution piping system. Many of the septic tanks used now are multi-compartment tanks that successively treat the wastewater. Septic tanks include compartments into which waste flows, and a pump transfers the partially-treated wastewater out of the tank and into the distribution piping system.

Watery waste (i.e., “effluent”) fills most of the septic tank. Anaerobic bacteria begin breaking down the organic material in the effluent. Septic tanks hold the wastewater long enough to allow solids to settle to the bottom of the tank, forming sludge. This bottom sludge layer is composed of inorganic solids and the byproducts of bacterial digestion. A layer of scum floats to the top. Scum is primarily composed of fats, greases, and oils. The septic tank acts like a settling pond. That is, greases and oils float to the top. Heavier solids sink to the bottom, and the effluent middle layer exits the tank. A filter prevents most solids from entering the outlet pipe. Septic tanks also allow partial decomposition of the solid materials. In this pre-treatment portion of the septic system, many of the contaminants are removed from the wastewater to prepare it for final treatment and discharge into the environment. Contaminants in the wastewater include harmful bacteria that can cause illness, as well as nitrogen and phosphorus that can stimulate algae growth and water bodies.

The liquid wastewater (effluent) then exits (e.g., is pumped out of) the septic tank and flows out into the drain field for further treatment in the soil while the sludge and scum from the tank are periodically pumped out. The drain field or leach field also remove contaminants from the wastewater. The drain field is a shallow, covered, excavation made in unsaturated soil. Pretreated wastewater is discharged through piping onto porous surfaces that allow wastewater to filter though the soil. The soil accepts, treats, and disperses wastewater as it percolates through the soil, ultimately discharging to groundwater. Gravity flow systems are the most widely used and least expensive, and they require the least amount of operation and maintenance. The drain fields are typically subsurface and include gravel filled trenches, plastic chambers or plastic perforated pipe installed underground to hold and then release wastewater leaving the tanks. The wastewater seeps into the surrounding soil, and the soil provides most of the wastewater treatment. Soil particles filter solids and organic matter from the wastewater. Microbes living in the soil breakdown the solids and kill the bacteria and pathogens in the wastewater. If a drain field is overloaded with too much liquid, it can flood, causing sewage to flow to the ground surface or create backups in toilets and sinks.

Similarly, if the filter in the septic tank becomes clogged, the liquid level in the septic tank rises, often higher than the top of the incoming sewer line, and sewage can back up in toilets, sinks, and drains in the house, which can cause catastrophic damage to the house. Many factors contribute to clogging septic tank filters. Waste that decomposes slowly (or not at all) gets flushed down drains. Cigarette butts, diapers and coffee grounds often cause problems. Likewise, if used heavily, garbage disposers can send too much solid waste into the system and can clog the filters. Lint from synthetic fibers are separated during machine washing cycles can often cause problems as bacteria in the septic tank and drain septic field often cannot break down the synthetic fibers. The effluent filters protect the septic system by filtering out effluent as it leaves the tank. The effluent filters often prevent the pipes in the drain field from clogging. If the effluent filter clogs, sewage can back up into the house.

Clogged filters can cause an above-normal rise in the static water level in the septic tanks. Once the filters are clogged, items can rise or pass into the pump chamber and damage the pump, or worse, when the filter screens are clogged, waste from the septic tank can bypass the filter and enter the pump chamber of the tank and subsequently the associated drain field. These particles will eventually clog the drain field and cause a sewage backup. Additionally, as solids accumulate on the filter medium, the differential pressure across the filter medium increases, and the fluid flow rate out of the septic tank decreases. Further, solids retained on the filter can slough due to gravitational force and begin to form a sediment that collects at the bottom of the filter assembly and further decreases the efficiency of the filtration system.

To service conventional filters requires opening the septic tank, manually removing the filter screens, clearing debris and solids that cling to the filter screens, and washing the filters and screens with a hose or in a container, which are messy and unsanitary jobs. Any sedimentation located at the bottom of the filter must also be removed. Often, the solid materials present health hazards, so plumbers and technicians wear appropriate protective gear. The difficulty in servicing conventional filters often results in neglect of the filters and long overdue service intervals.

Some septic tank effluent filters purport to be self-cleaning by backwashing or flushing the filters to prevent clogging, but often these systems prove to be inadequate because the reversed flow through the filter element lacks sufficient hydrodynamic shear forces to remove the accumulated solids. Even when the accumulated solids are successfully removed from the filter, they can collect at the bottom of the filter and again inhibit the flow. This results in the septic system being taken offline and placed out of service while additional cleaning operations are performed. Some backwash septic systems require secondary piping dedicated solely to the backwashing process to introduce, circulate, and remove the backwashing fluid and removed solids.

Other filter systems include a rotary design that is akin to a strainer that directs the effluent to flow radially through the filter screen and into the interior of the strainer. A pump has an inlet port that is disposed downstream of the strainer along the direction of the effluent flow. An outlet pipe pumps the effluent out of the septic tank. A portion of the pumped effluent is directed toward the cylindrical filter screen opposite the effluent flow to act upon the filter screen and dislodges some of the debris from the filter screen.

Further, other existing filter cleaning systems can only be used in those septic systems that utilize a lift station or other secondary components and pumps to move effluent from the septic tank to a higher location. In these systems, there are typically two separate tanks. The first tank receives the wastewater from the dwelling through an inlet baffle, and the effluent leaves the first tank through an outlet baffle to a secondary tank (e.g., lifting station, pump tank, etc.). The secondary tank includes a pump to move the effluent to a higher elevation, such as a septic field that is built on higher ground. The existing filter cleaning systems rely on the action of the lifting station (pump tank) to move water up and down in the main tank to scrub the filter.

Existing systems do not include adequate cleaning mechanisms or processes to provide successful self-cleaning of the effluent filters without taking the filters or system offline and instead implement solutions that inadequately treat the filters. Some existing mechanical methods tend to damage the filter media, while air scouring alternatives are less destructive of the filter media but less effective in cleaning the filter. Other existing systems require extensive secondary piping systems dedicated to backwashing operations and additional fluid dynamics. Still other systems utilize multiple filter stages, but the shortcomings associated with many of the conventional single filter systems apply to multiple filter stages as well.

### SUMMARY

Prior technical efforts often focused on systems for cleaning filters that required intrusive disassembly of existing septic systems, including removal of effluent filters. Other effluent filter cleaning systems can only be used with those septic systems that incorporate lift stations (pump tanks) to move waste from a lower elevation to a higher elevation. The claimed invention provides an improved automatic filter cleaning apparatus that removes clogged sediment without the need to take the septic system offline for long periods of time. It can be used with new gravity-driven septic systems or retrofitted to existing systems. While the invention can be used with septic systems that rely upon lift stations, it does not require the additional components or complexity of those systems. When used on septic systems with lift stations, the system of the invention is installed on the outlet baffle of the first tank. The invention includes self-cleaning effluent filters, pumps, float switches, high water alarms, and collectors/strainers to hold the suspended solids once they are removed from the filter medium.

To prevent the effluent filters from becoming clogged, or to unclog existing filters, the invention initiates a scrubbing process as two spring-loaded flappers are closed on the inlet and outlet sides of the baffle that houses the effluent filter. An internal spray bar with outlet ports scrubs the effluent filter, and large holes or perforations in the filter assembly allow solids to enter an outer chamber. These solids move or float upward and are collected in a collector/strainer at the water line in the tank. As the cleaning process is completed, the solids are retained in the collector/strainer to decompose or to be removed at a later time. A float switch controlling the cleaning pump returns the pump to an off position. The spring-loaded flappers open to allow the septic tank and filter to resume their normal flow, and the water level in the septic tank returns to an appropriate height below the incoming sewer line. The building now has full sewer service. The systems and methods of the invention prevent sewage backup inside the home.

The invention includes systems and methods for automatically cleaning a septic tank effluent filter. In one example embodiment of the invention, the system includes an outlet baffle that receives effluent water from an inlet pipe sewer line, an inlet flapper spray jet that sprays effluent water toward an inlet flapper causing the inlet flapper to close to prevent additional effluent water from entering the outlet baffle, and an outlet flapper spray jet that sprays effluent water toward an outlet flapper causing the outlet flapper to close to prevent effluent water from leaving the outlet baffle. The invention also includes a spray outlet that sprays effluent water toward an effluent filter to remove debris from the effluent filter. An outer chamber receives the removed debris from the effluent filter and channels the debris to a strainer, which retains the removed debris while allowing the effluent water to return to the septic tank.

Some embodiments of the invention have the spray outlet disposed coaxially and circumscribed within a cylindrical interior of the effluent filter to constrain the flow of the effluent water to pass radially through the effluent filter.

Implementations of the invention can utilize an effluent filter that includes a filter screen disposed coaxially along a longitudinal axis of the effluent filter to catch debris suspended in the septic tank.

The invention can also include a collar disposed coaxially and circumscribing the vertical pipe. The collar can be and mounted to the filter screen and can be circumscribed by the filter screen so that the effluent filter can rotate relative to the vertical pipe about their shared axis. This rotational movement causes effluent water to act upon the filter to further remove debris.

Embodiments of the invention can utilize an outer chamber that is disposed on the interior of the outlet baffle. In one example implementation, the outer chamber is disposed on the interior of the outlet baffle along an outer wall. The removed debris from the effluent filter moves through the outer chamber to the strainer.

Some examples of the invention incorporate a strainer that includes a separation medium that separates the removed debris from the effluent water. Additionally, the invention can channel the debris to the strainer by affecting the flow of the effluent water and debris in the outlet baffle 280 into the outer chamber and to the strainer, which retains the removed debris 290 and returns the effluent water 284 to the septic tank.

Example implementations of the invention include an automatic effluent filter cleaning system that further includes a float switch for controlling initiation and completion of the spraying of effluent water toward the inlet flapper, the outlet flapper, and the effluent filter. Similarly, some embodiments of the invention also include a pump in fluid communication with the inlet flapper spray jet, the outlet flapper spray jet, and the spray outlet, and the pump moves effluent water to the inlet flapper spray jet, the outlet flapper spray jet, and the spray outlet.

The invention includes systems and methods that automatically commence a scrubbing process to prevent the effluent filters from becoming clogged, or to unclog existing filters. The invention closes spring-loaded flappers on the inlet and outlet sides of the (outlet) baffle that houses the effluent filter. An internal spray bar with outlet ports scrubs the effluent filter, and large holes or perforations in the filter assembly allow solids to enter an outer chamber. The solids are collected in a collector/strainer at the water line in the tank. When the cleaning process is completed, the solids are retained in the collector/strainer to decompose or to be removed at a later time. A float switch controls a cleaning pump and returns it to an off position at the end of the process. The spring-loaded flappers then re-open to allow the septic tank and filter to resume their normal flow. The water level in the septic tank returns to an appropriate height below the incoming sewer line, and the building now has full sewer service. In this fashion, the systems and methods of the invention prevent sewage backup inside the home.

### BRIEF DESCRIPTION OF THE DRAWINGS

FIG. 1 shows an example septic system in accordance with the invention with high effluent water levels in a septic tank due to a clogged filter.

FIG. 2A shows an example septic system as a pump initiates an automatic cleaning process in accordance with the invention and high effluent water levels in a septic tank due to a clogged filter are pumped out of the tank.

FIG. 2B shows a detailed view of a self-cleaning septic effluent filter in accordance with the invention in a cleaning cycle.

FIG. 3A shows an example septic system as the pump completes an automatic cleaning process in accordance with the invention and effluent water levels in a septic tank return to acceptable levels.

FIG. 3B shows a detailed view of a self-cleaning septic effluent filter in accordance with the invention upon completion of a cleaning cycle.

FIG. 4 shows a top cross-sectional view of the vertical pipe, collar, screen, and filter of an effluent filter system in accordance with the invention.

### DETAILED DESCRIPTION

The invention includes specially-configured septic tank effluent filter cleaning systems and methods that provide automated process improvements of viewership estimation for advanced consumer segments. The invention utilizes a unique approach to modeling viewership through the training of an ensemble of mathematical machine learning predictor models that work together to create the predictions of viewership at various time intervals and at various granular segments.

Prior effluent filter cleaning systems required dismantling of septic system components, along with removal of effluent filters to clean them. Other filter cleaning techniques can be used only with septic systems that have secondary tanks, such as lifting stations (pump tanks). These systems use the lifting station pumps and piping to transfer waste from a lower elevation to a higher elevation. These systems incorporate two separate tanks. The first tank receives wastewater from the home through an inlet baffle, and the effluent leaves the first tank through an outlet baffle to the secondary tank (e.g., lifting station, pump tank, etc.). The secondary tank includes a pump to pump out the effluent to a higher elevation, such as a septic field that is built on a mound. The existing filter cleaning systems rely on the action of the lifting station (pump tank) to move water up and down in the main tank to scrub the filter.

The claimed invention includes an advanced automatic effluent filter cleaning system that eliminates clogged sediment without the need to take the septic system offline and without the need for a secondary tank. When used on septic systems with lift stations, the systems of the invention are installed on the outlet baffle of the first tank. The systems of the invention can be used with new gravity-fed septic systems or retrofitted to legacy systems. Likewise, they can be used with new lifting station systems or retrofitted to outlet baffles in the first tanks of legacy lifting station systems.

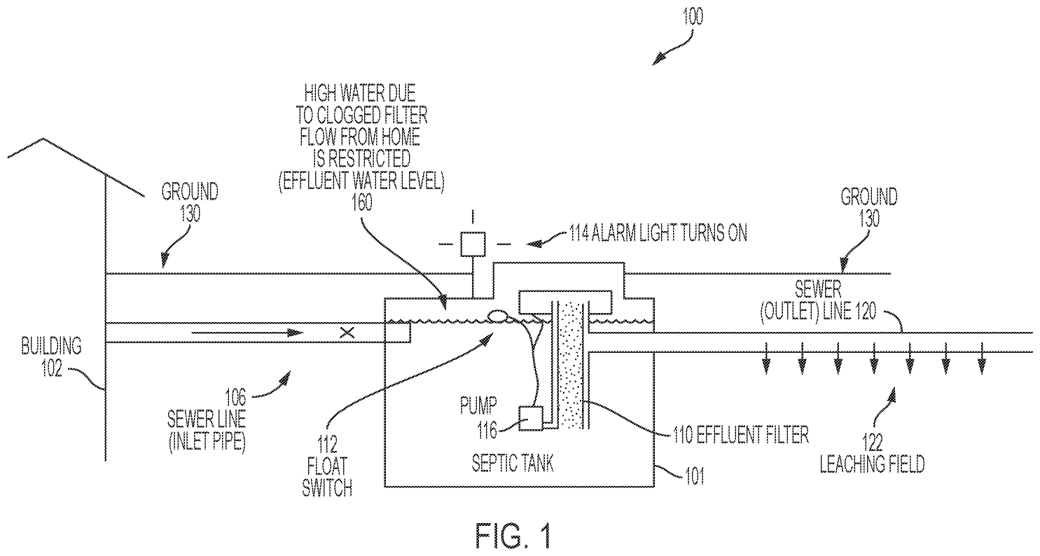

FIG. 1 shows a septic tank automatic effluent filter cleaning system 100 in accordance with the invention. The system includes a septic tank 101 and a sewer line 106 (inlet pipe) that moves sewer water from building 102 into the septic tank 101. Once the effluent filter cleaning is complete, sewer water leaves the septic tank 101 via sewer line 120 (outlet pipe) into leaching field 122.

FIG. 1 shows a high effluent water level 160 caused by a restricted flow of sewer water from building 102 into the septic tank 101 and into leaching field 122. The sewer line 106, septic tank 101, sewer line 120, and leaching field 122 are all below the ground 130. In FIG. 1, the effluent water level 160 in the septic tank 101 is higher than (above) the sewer line 106 (inlet pipe) causing restricted flow from the building 102. In many cases, the cause of the high-water level is that the effluent filter 110 in the septic tank 101 has become clogged. In some example implementations, a float switch 112 operates in conjunction with a high-water alarm, such as alarm light 114, for example, to warn the homeowner of a high-water condition and the danger associated with it.

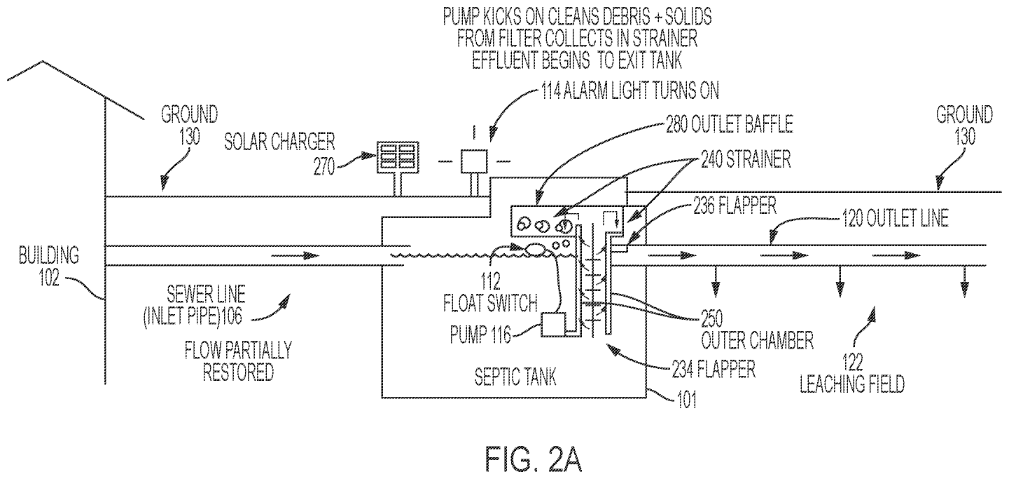

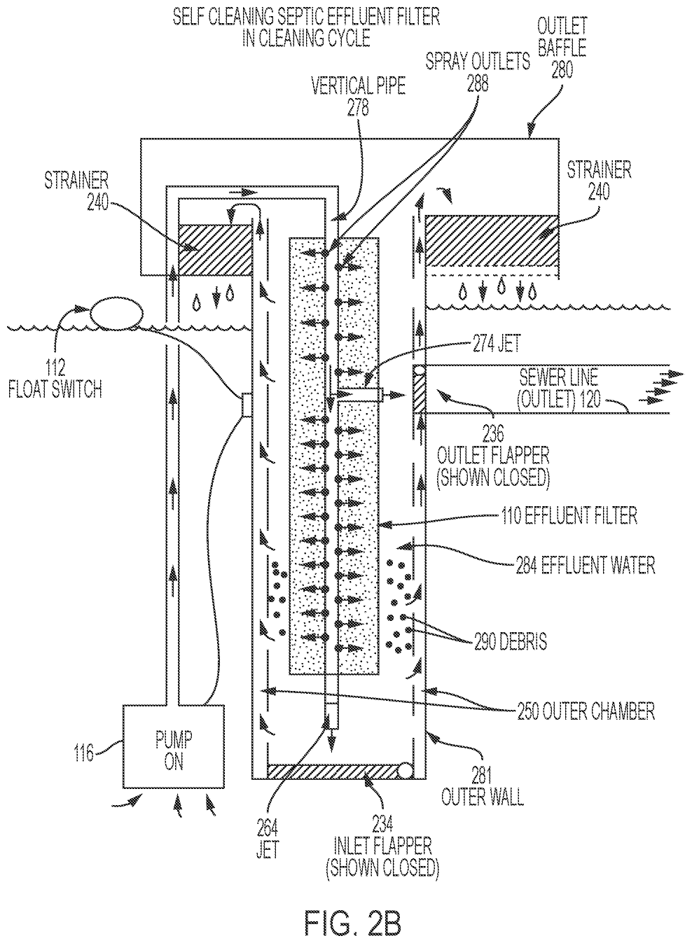

FIGS. 2A and 2B shows the system 100 as the invention begins to clean the clogged effluent filter 110. As the float switch 112 senses the high-water level 160, the float switch 112 turns on the cleaning pump 116 to pump effluent water out of the septic tank 101 via sewer line 120 into leaching field 122. The cleaning pumps 116 of the invention are designed and manufactured to move water slower than conventional pumps as further described below. The cleaning pump 116 turns on and draws effluent water from the middle column of the septic tank 101. As outlined above, the middle column in the septic tank 101 is below the scum layer at the top of the tank 101 where greases and oils collect, and above the sediment layer at the bottom of the tank 101 where solid wastes settle. While the cleaning pumps 116 of the invention can be energized by a 110 VAC or 220 VAC circuit, such as from building 102 or from other sources, the cleaning pump 116 can also run off an optional solar charging circuit 270. The solar charging circuit 270 can be incorporated when upgrading existing septic systems to eliminate the need to run additional power lines from building 102 or from other sources to power cleaning pumps 116 or other electrical components of the invention.

Upon receiving a high water level signal from float switch 112, the cleaning pump 116 energizes and begins moving effluent water slowly so the water flow does not disturb the settled sludge on the bottom of the tank 101 nor does it mix the scum at the top of the tank 101. Prior to the cleaning pump 116 turning on to begin the cleaning cycle, the (outlet) baffle inlet flapper 234 is open to allow effluent water to rise up through the filter 110 and through the outlet baffle 280 and out of the septic tank 101 via an open outlet flapper 236 and sewer line 120 (outlet line). For example, the (outlet) baffle inlet flapper 234 and outlet flapper 236 can be held open with a spring and/or a buoyant or semi-buoyant material in or on the flappers that allow the effluent water to freely travel up the outlet baffle 280, through the effluent filter 110, out through the outlet flapper 236, out of the tank 101, and into the leaching field 122 via outlet line 120. When a cleaning cycle begins, the jet 264 at the bottom of the outlet baffle 280 directs water to the inlet flapper 234, which closes the flapper 234. The jet 264 can be a small pipe or other tube (e.g., a PVC pipe) that directs water against the inlet flapper 234 to close the flapper 234 and prevent effluent water from traveling up the outlet baffle 280. Similarly, when the cleaning pump 116 turns on and the system 101 begins a cleaning cycle, another jet 274 in line with the outlet flapper 236 directs water against the outlet flapper 236 to close the flapper 236, which prevents effluent water from leaving the tank 101 into sewer outlet line 120. The flappers 234, 236 can close against rubber seals or other sealing mechanisms on the baffle to ensure a water-tight seal and to help direct the flow of debris into the outer chamber 250 (discussed further below).

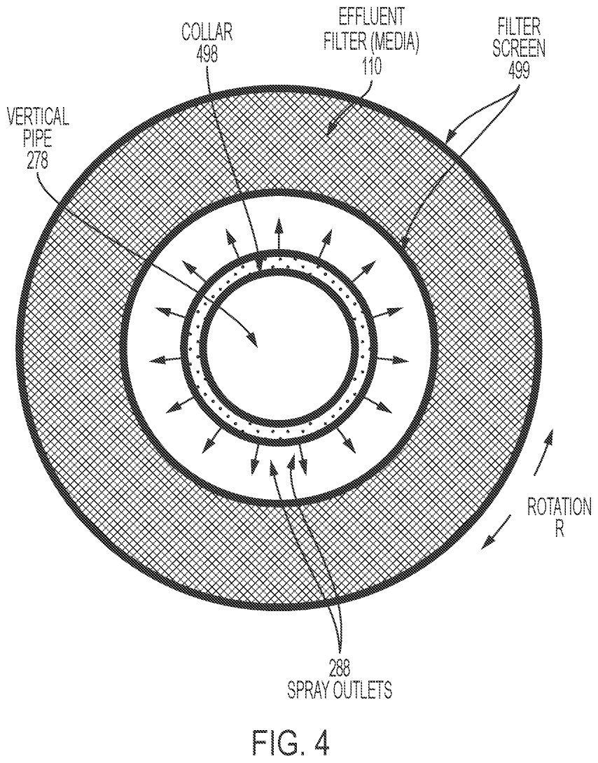

As the cleaning cycle depicted in FIGS. 2A and 2B proceeds, the cleaning pump 116 continues to force effluent water through the system 100, including through vertical spray bar 278. Vertical spray bar 278 is equipped with spray outlets 288 through which effluent water is forced out and onto the effluent filter (medium) 110. The sprayed water leaving spray outlets 288 contacts the medium of the effluent filter 110 and removes debris, including solids that had clung to the filter medium. The filter media can include biological, mechanical, and chemical media used to strain solids from the effluent water passing through the media. The materials used in the filter media can include materials from organic carbon-based substances to synthetic plastics, including activated carbons, diatomaceous earth, activated clay, cellulose, ceramic materials, cotton, glass fibers, ion exchange materials, mixed resins, metal or porous metal filter media, sand, nylon, paper, plastics, polyethersulfones (PES), polyester, polypropylene (PP), PTFE, polyvinylidene fluoride (PVDF), polyvinylidene chloride (PVDC), polysulfone (PSU), and other filter media shaped as bristles, screens, cloth, foam, peat, textiles, and other media surfaces. In some embodiments of the invention, the effluent filter 110 can include one or more screens (reference numeral 499 in FIG. 4) that can enclose the filter media. In some example embodiments, the screen 499 can rotate coaxially with respect to the vertical pipe 278 as shown by reference element R in FIG. 4. In other embodiments, the vertical pipe 278 can rotate with respect to the screen 499. A collar 498 can be used to mount the screen 499 to the vertical pipe 278 and to affect the rotation.

The spray outlets 288 force effluent water to contact the filter media, which removes the clinging solids and debris 290. The debris 290 travels from the bristles (or other materials of the) filter 110 into the effluent water 284 and are directed into perforations or other holes in the outer chamber 250 of the outlet baffle 280, where the debris 290 travels vertically toward the top of the outlet baffle 280. The debris is then direct to and is captured by the collector/strainer 240 of the outlet baffle 280. The debris 290 can be removed from the collector/strainer 240 on a periodic basis or as needed, or the debris 290 can be left to decompose. The collector/strainer 240 is positioned above the water level in the septic tank 101. Debris-free effluent drips back into the septic tank 110 after passing through the collector/strainer 240.

In some example implementations of the invention, the collector/strainer 240 is a corrosion-free steel mesh that mechanically removes particulate debris from the effluent filter (bristles, for example) that was suspended in the effluent water. In other example implementations of the invention, the collector/strainer 240 is a perforated metal, mesh, or wedge wire straining element. The collector/strainer 240 can be a planar component or can be a variety of geometrical shapes, including cylindrical, spherical, cubic, or a stack or other combination of shapes. Some of the collector/strainers 240 in accordance with the invention can be removed by a service technician or by a homeowner and cleaned and the returned to service. Other collectors/strainers 240 of the invention are disposable and can be removed and replaced periodically.

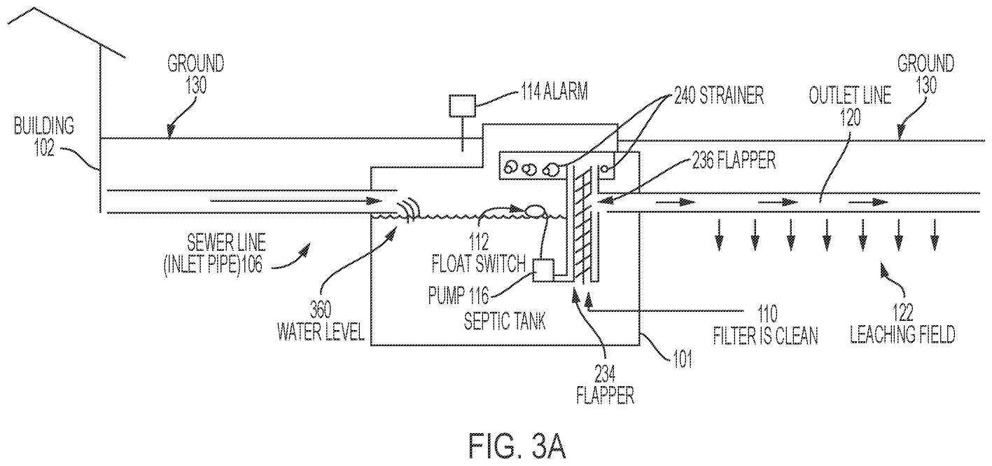

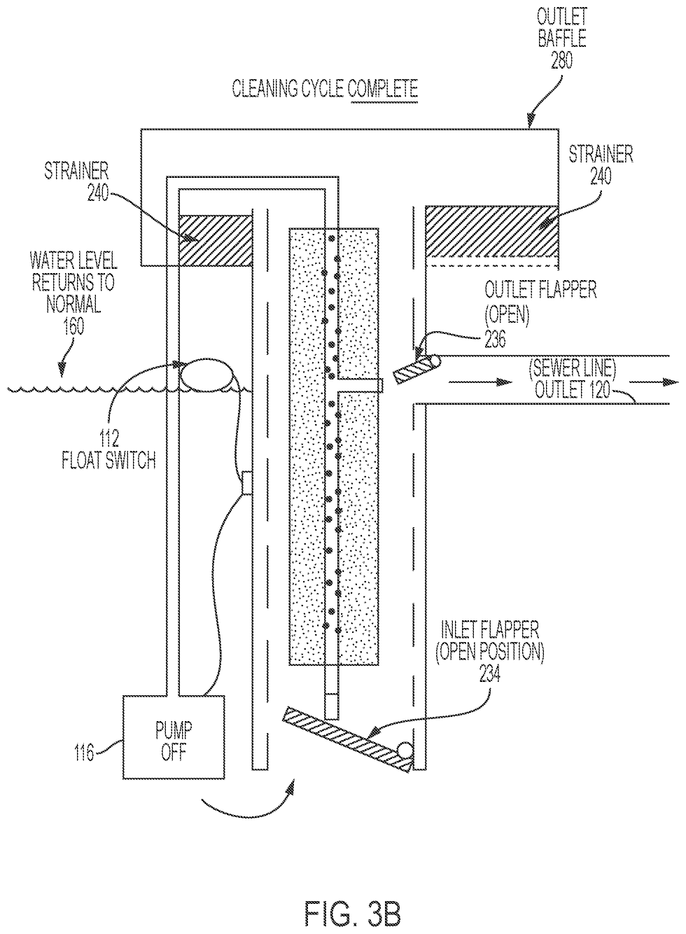

As shown in FIGS. 3A and 3B, as the cleaning pump 116 continues to run, and the spray outlets 288 continue to remove debris 290 from the effluent filter 110, the debris is collected in the collector/strainer 240. After a period of time, enough debris is removed from the effluent filter 110 and removed from the tank 110 into collector/strainer 240, that the water level 360 begins to recede, as the system 100 is becoming unclogged. As the effluent water level 360 recedes to an acceptable level, the float switch 112 turns off the cleaning pump 116. The spring-loaded inlet flapper 234 and outlet flapper 236 return to an open position, allowing effluent water to flow freely from the septic tank 101 through the clean filter 110, as the system resumes its normal flow. The water level 360 is at an appropriate height below the sewer line 106 (inlet pipe) and the building 102 now has full sewer service.

The systems and methods of the invention prevent effluent filters from becoming clogged by initiating a scrubbing process that removes solid and particulate debris from effluent filter media. The solids are displaced from the effluent filter by a cleaning pump and are removed from the septic and are collected in a strainer above the water line in the tank. As the cleaning process is completed, the solids are retained in the strainer to decompose or be removed at a later time. A float switch controls the cleaning pump and initiates the scrubbing process. By automatically self-cleaning the effluent filter, the systems of the invention prevent disastrous sewer line backups and that damage that results.

The claimed invention is:

1. An automatic septic tank effluent filter cleaning system 100 comprising:
an outlet baffle 280 that receives effluent water 284 from an inlet pipe sewer line 106;
an inlet flapper spray jet 264 that sprays effluent water 284 toward an inlet flapper 234 causing the inlet flapper 234 to close to prevent additional effluent water from entering the outlet baffle 280;
an outlet flapper spray jet 274 that sprays effluent water 284 toward an outlet flapper 236 causing the outlet flapper 236 to close to prevent effluent water from leaving the outlet baffle 280;
a spray outlet 288 that sprays effluent water 284 toward an effluent filter 110 to remove debris 290 from the effluent filter 110;
an outer chamber 250 that receives the removed debris 290 from the effluent filter 110 and channels the debris 290 to a strainer 240, which retains the removed debris 290 while allowing the effluent water 284 to return to the septic tank.

2. An automatic effluent filter cleaning system of claim 1, wherein:
the spray outlet 288 is disposed coaxially and circumscribed within a cylindrical interior of the effluent filter 110 and to constrain flow of the effluent water to pass radially through the effluent filter 110.

3. An automatic effluent filter cleaning system of claim 1, wherein:
the effluent filter 110 includes a filter screen 499 disposed coaxially along a longitudinal axis of the effluent filter 110 and to catch debris 290 suspended in the septic tank.

4. An automatic effluent filter cleaning system of claim 3 further comprising:
a collar 498 disposed coaxially and circumscribing the vertical pipe 278 and mounted to and circumscribed by the filter screen 499 for rotation of the effluent filter 110 relative to the vertical pipe 278 about their shared axis.

5. An automatic effluent filter cleaning system of claim 1, wherein:
the outer chamber 250 is disposed interior to and along an outer wall 281 of the outlet baffle 280 and through which removed debris 290 from the effluent filter 110 is moved to the strainer 240.

6. An automatic effluent filter cleaning system of claim 1, wherein the strainer 240 includes a separation medium that separates the removed debris 290 from the effluent water 284.

7. An automatic effluent filter cleaning system of claim 1, wherein channeling the debris 290 to the strainer 240 includes affecting the flow of the effluent water 284 and debris 290 in the outlet baffle 280 into the outer chamber 250 and to the strainer 240, which retains the removed debris 290 and returns the effluent water 284 to the septic tank.

8. An automatic effluent filter cleaning system of claim 1 further comprising:
a float switch 112 for controlling initiation and completion of the spraying of effluent water toward the inlet flapper, the outlet flapper, and the effluent filter.

9. An automatic effluent filter cleaning system of claim 1 further comprising:
a pump 116 in fluid communication with the inlet flapper spray jet 264, the outlet flapper spray jet 274, and the spray outlet 288, and for moving effluent water to the inlet flapper spray jet 264, the outlet flapper spray jet 274, and the spray outlet 288.
